(19) United States
(12) Patent Application Publication
(10) Pub. No.: US 2014/0120860 A1
(43) Pub. Date: May 1, 2014

(54) SYSTEMS AND METHODS FOR USER CUSTOMIZED SECURITY RESPONSES

(71) Applicant: David Amis, Dwango, CO (US)

(72) Inventor: David Amis, Dwango, CO (US)

(21) Appl. No.: 13/660,145

(22) Filed: Oct. 25, 2012

(51) Int. Cl. H04W 88/02

(52) U.S. Cl. 455/404.1

(57) ABSTRACT

The disclosure generally relates to systems and methods for user customized security response protocols. In an embodiment, users can select the type of security response provider that is contacted during a distress signal, as well as a time and/or scenario at which the selected security response provider is contacted. Users can furthermore select the way in which security protocols are implemented. Users can also customize the order in which different types of security response providers are contacted to provide assistance, as well as select security response providers that are closest to the user at a given time.

### CROSS-REFERENCE TO RELATED APPLICATIONS

The present application is related to U.S. Non-Provisional patent application Ser. No. 12/862,117, filed on Aug. 24, 2010, which claims the benefit of U.S. Provisional patent application No. 61/236,265, filed on Aug. 24, 2009. The present application further claims the benefit of U.S. Provisional patent application No. 61/610,554, filed on Mar. 14, 2012. The contents of each of the afore-mentioned patent applications are hereby incorporated by reference in their entireties.

### BACKGROUND

1. Field of the Invention

The present invention relates generally to the field of personal safety management, and more specifically, to systems and methods of allowing users to customize how they interact with, and initiate contact with, a variety of security response providers and protocols to improve their safety both pre-incident, post-incident, and during an incident.

2. Description of Related Art

Recent advances in mobile computing and wireless technology have transformed traditional mobile phones into invaluable tools that help users with not only communicating with others, but also with managing all aspects of their personal lives and business activities. Mobile devices are increasingly being used for personal safety management as well, where mobile devices can be used to capture evidence, thwart potential perpetrators, and transmit an alarm for help.

However, mobile phones are very visually intensive devices, whereby users must look at the device in order to manipulate it. It is very difficult for current mobile devices to be correctly operated while the devices are concealed. A user cannot normally discern the current state of the device without looking at it, and therefore cannot be sure as to the current location or state of various on-screen buttons and controls at any given time. This makes it difficult to control the device while it is one's pocket, or while one is engaged in a situation or task that prevents one's ability to look at the device.

For example, consider a scenario when a victim is abducted and is being threatened with violence. In the presence of a perpetrator, it is likely that the victim is hesitant to take out their mobile phone in plain sight and call or text for help, since the perpetrator would most certainly escalate violence and/or confiscate or destroy the mobile phone. The victim is only a single call away from help, but ironically remains helpless because they cannot use their mobile phone in plain sight.

Therefore, there is a need for systems and methods that overcome the deficiencies of traditional mobile devices so that users can easily manipulate and operate a mobile device while it is concealed.

### SUMMARY

In an embodiment, the present invention provides a communication device for use in a concealed environment, comprising a casing; a communication means located within the casing; and at least one mechanical switch located on the casing, wherein the communication means is configured to transmit a signal to a remote location upon actuation of the mechanical switch.

In another embodiment, the present invention provides a communication device that provides haptic feedback, comprising a handset having a screen; a communication means coupled to the handset; and at least one pressure-sensitive trigger region located on a pre-determined portion of the screen, wherein the communication means is configured to transmit a signal to a remote location upon application of pressure to the trigger region.

In yet another embodiment, the present invention provides a mobile device for personal safety management, comprising a casing; a screen placed adjacent to the casing; at least one switch located on the casing or on the screen, the switch configured to provide tactile feedback; and a communication means located within the casing, the communications means configured to transmit a distress signal to a remote location signal upon receipt of a pre-determined input to the at least one switch.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a schematic of personal safety communications network in accordance with an embodiment of the present invention;

FIG. 2A is a front view of a mobile device with protruding portions in accordance with an embodiment of the present invention;

FIG. 2B is a side view of a mobile device with protruding portions in accordance with an embodiment of the present invention;

FIG. 3A is a front view of a mobile device with protruding shaped portions in accordance with an embodiment of the present invention;

FIG. 3B is an elevated side view of a mobile device with protruding shaped portions in accordance with an embodiment of the present invention;

FIG. 4A is a front view of a mobile device with flush portions in accordance with an embodiment of the present invention;

FIG. 4B is a side view of a mobile device with flush portions in accordance with an embodiment of the present invention;

FIG. 5A is a side view of a mobile device with indented portions in accordance with an embodiment of the present invention;

FIG. 5B is a side view of a mobile device with an indented portion with a button in accordance with an embodiment of the present invention;

FIG. 6A is a front view of a mobile device with a mechanical slide switch in accordance with an embodiment of the present invention;

FIG. 6B is a side view of a mobile device with a mechanical slide switch in accordance with an embodiment of the present invention;

FIG. 7 is a front view of a mobile device with touch-sensitive buttons in accordance with an embodiment of the present invention;

FIG. 8 is a side view of a mobile device with a Braille-type manipulation system in accordance with an embodiment of the present invention;

FIG. 9 is a side view of a mobile device with an access switch in accordance with an embodiment of the present invention;

FIG. 10 is a front view of a mobile device with a dedicated alarm region on the screen in accordance with an embodiment of the present invention;

FIG. 11 is a front view of a mobile device with a dedicated slide region on the screen in accordance with an embodiment of the present invention; and

FIG. 12 is a flowchart illustrating the steps of triggering a distress signal in accordance with an embodiment of the present invention.

### DETAILED DESCRIPTION

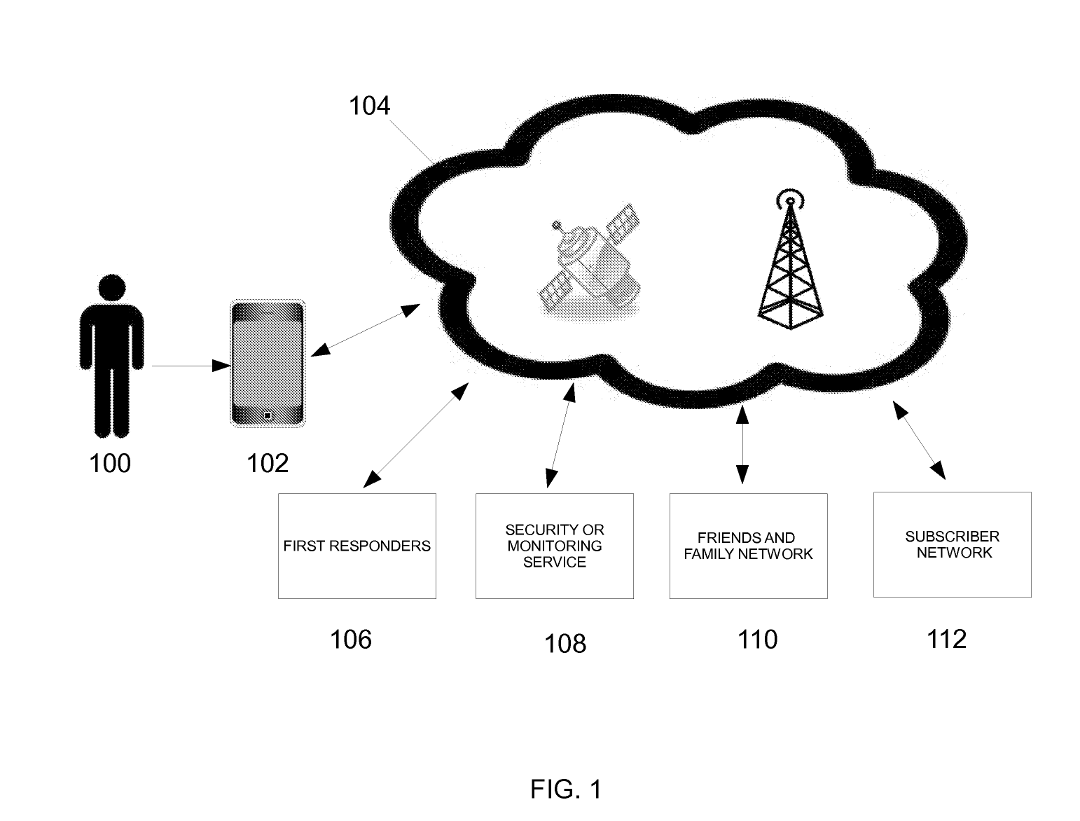

FIG. 1 is a schematic of personal safety communications network in accordance with an embodiment of the present invention. Referring to FIG. 1, the personal safety communications network can include a mobile device 102 which is located on or near the user 100. In a preferred embodiment, the user 100 can be a person, such as a child, elderly person, disabled person, a person living alone, a real estate agent, a mail courier, an undercover law enforcement agent, a postal delivery worker, a teenager, a single female, a disabled person, etc., each having a personalized suite of security services and third-party responses based on their activity, accessibility, vulnerability, and potential occupational hazards.

The mobile device 102 is communicatively coupled to a network 104, which can consist of a satellite communication system, at least one cellular phone tower, a wireless communication node, or any combination thereof. Furthermore, any type of standard or non-standard communication system/protocol which allows for positioning and data transmission can be used.

The network 104 is communicatively coupled to various third-party response providers, such as first responders 106, private monitoring/security providers 108, and/or a user's personal friends/family network 110.

The first responders 106 can include police departments, emergency medical service (EMS) providers, fire and rescue departments, volunteer organizations, volunteers, employees, 911 emergency centers, include federal agencies, task forces, non-governmental agencies, relief agencies and workers, and the military.

The user's personal friends/family network 110 can include a pre-determined list of contacts to which a distress signal is automatically transmitted. The contacts can receive a text message, multi-media message (MMS), email, Facetime alert, a phone call with a recorded distress message, live phone call from a 911 or private monitoring center dispatch, live audio from the user's mobile device, a social network notification (i.e., Facebook, MySpace, Orkut, LinkedIn, etc.), an instant messenger notification, or any combination thereof as an indication of the distress signal.

The private monitoring/security providers 108 can offer a subscription-based service that monitors the mobile device 102 as described in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein.

The safety communications network depicted in FIG. 1 allows for multi-directional (i.e., two-way, and three-way) communications. That is, a third-party response provider can receive data from the mobile device 102, and can also transmit data to the mobile device 102 via the network 104, as well as to the other third-party response providers.

The mobile device 102 can be a standalone personal safety device, or can be incorporated into a cellular phone, portable music player, keychain, pager, PDA, or other portable communication device. In another embodiment, the mobile device 102 can be worn on the user 100, such as around the user's neck (i.e., necklace or dog collar), ankle (i.e., anklet or ankle bracelet), or as a wristband (i.e., watch strap, watch). In a preferred embodiment, the mobile device 102 is a multi-function device that includes signal reception and transmission capabilities, and includes a cellular phone capability that allows the user 100 to communicate with a remote location.

In a preferred embodiment, the mobile device 102 is an off-the-shelf smart phone or device, such as an iPhone, iPod, iPad, Blackberry, Android, or other similar system. The off-the-shelf device can be loaded with applications or software that enables the off-the-shelf device to act as a mobile device 102 of this invention. For example, a user can download an application from the Internet, Android Marketplace, and/or the Apple Apps Store that includes facilitates the triggering of the distress signal by the user 100 as described below. In an embodiment, the user can pay a one-time or monthly subscription fee to the software provider to gain access to the downloadable applications. Alternatively, the user can download the applications for free, and receive a limited-time or limited-feature access to try the distress signal functionality. The user must then purchase a subscription to “unlock” the full capabilities and have unlimited access to the software application.

In another embodiment, the mobile device 102 is a standalone device that includes hardware features as described below. While software applications may be downloaded or programmed onto the mobile device 102, the casing, screen and physical construction of the device facilitate the triggering of the distress signal by the user 100.

The distress signal can be a data signal indicating an alarm, and can include position data. In an embodiment, the distress signal can also include audio data, so that once the distress signal is activated on the mobile device 102, a microphone on the mobile device 102 can capture and transmit any audible sounds from the user's environment to the third-party response provider in real-time. In yet another embodiment, a camera on the mobile device 102 can automatically be activated once the distress signal is activated. In the event the mobile device 102 is removed from its concealed location (i.e., pocket, purse, handbag, etc.), any video/image data from the user's environment will automatically be streamed to the third-party response provider in real-time. The audio and video data can also be stored on a memory located on the mobile device 102.

In yet another embodiment, the present invention is incorporated into a traditional landline phone system, where the receiver does not need to be lifted in order for a distress signal to be transmitted to a third-party response provider. The landline phone base can have a dedicated button or set of buttons through which the user 100 can activate a distress signal. The buttons can be part of the keypad or located on another part of the phone base. For example, the user can enter a pre-determined sequence onto the keypad that triggers a distress signal (assuming that the keypad is on the base and not on the receiver). This embodiment may be applicable to hotel settings or environments which do not receive a strong wireless signal, and the only viable option to communicate is a landline phone.

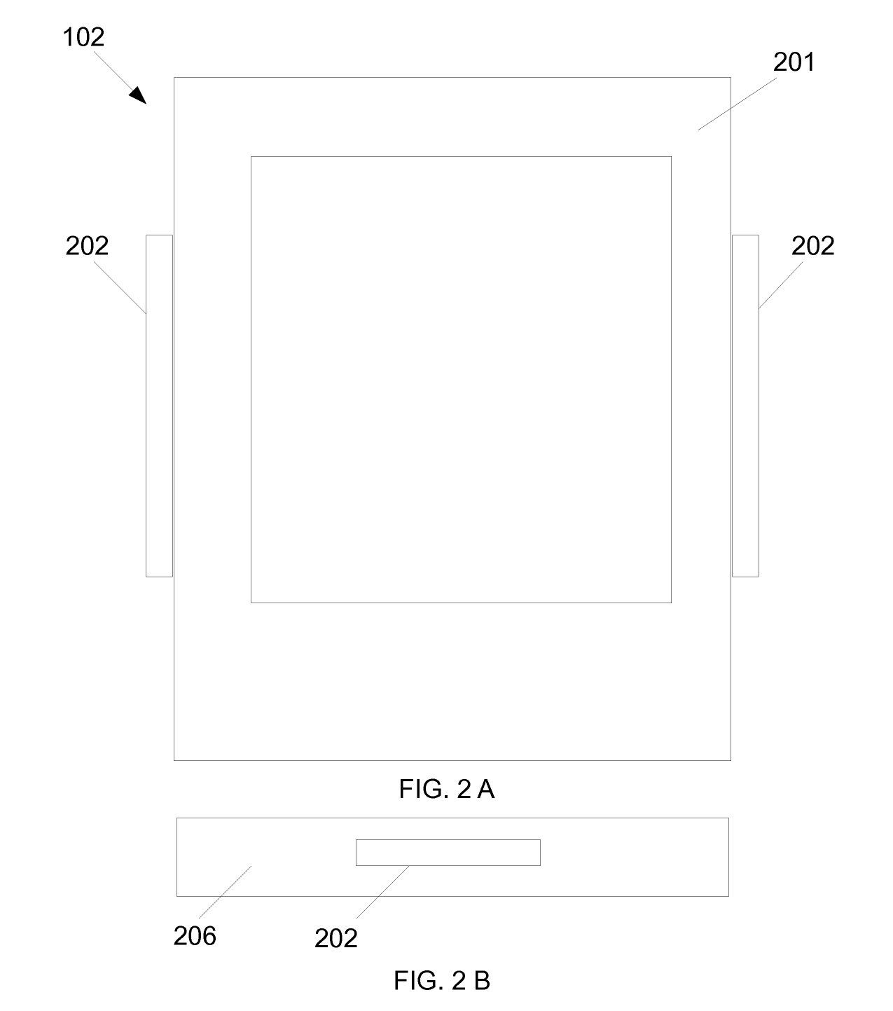

FIG. 2A is a front view of a mobile device 102 with protruding portions in accordance with an embodiment of the present invention. The mobile device 102 can include a casing 201 that has protrusions 202 located on each of the opposite sides of the casing 201. In an embodiment, the protrusions 202 are slightly raised from the casing 201, so that the user 100 can easily locate the protrusions 202 by feel. Upon a simultaneous depression of both protrusions 202, the mobile device automatically transmits a distress signal to a remote location, such as to at least one of the third-party response providers. For example, the user 100 can simply grasp the mobile device 102 and squeezes the protrusions 202 without having to look at the mobile device 102. Thus, the user 100 can activate the distress signal without taking it out of their pocket, purse, handbag, etc.

FIG. 2B is a side view of a mobile device 102 with protruding portions in accordance with an embodiment of the present invention. The protrusions 202 can be located on any side, front, or back portion of the casing 201, and their placement is not limited to the embodiment show in FIGS. 2A and 2B. Furthermore, multiple protrusions can be located on either side of the casing 201.

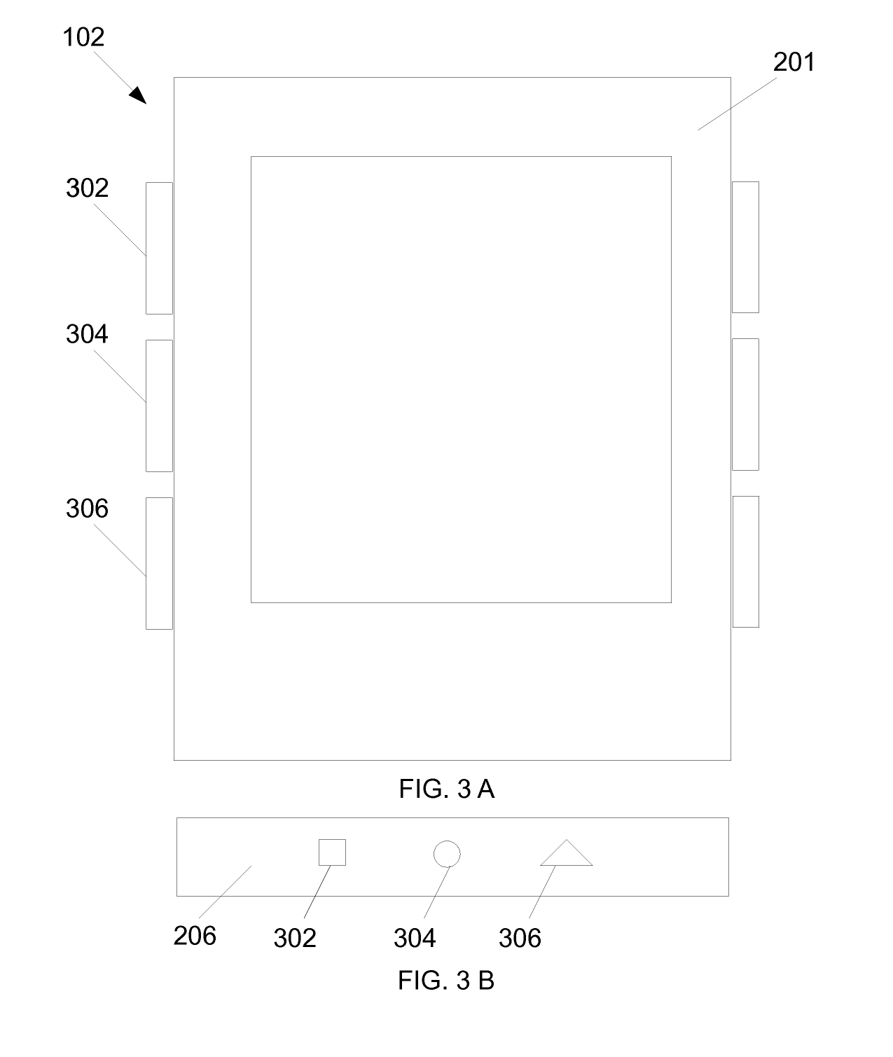

FIG. 3A is a front view of a mobile device with protruding shaped portions in accordance with an embodiment of the present invention. The casing 104 includes multiple protrusions 302-306, each of which has a unique shape as showing in FIG. 3B. For exemplary purposes, indentation 302 can be a square, indentation 304 can be a circle, and indentation 306 can be a triangle. The protrusions 302-306 can be located on a single side of the casing 104, or they can be located on any side, front, or back portion of the casing 201, and their placement is not limited to the embodiment show in FIGS. 3A and 3B.

In an embodiment, the user 100 can input a pre-determined sequence which can trigger a distress signal, such as (1) triangle, (2) square, (3) circle, or (1) circle, (2) circle, (3) square, etc. In this embodiment, the distress signal is only transmitted upon the exact sequence being entered into the mobile device 102, thus preventing accidental transmission of the distress signal.

In yet another embodiment, each of the different protrusions 302-306 can initiate a different command to the mobile device 102. For example, depression of the square protrusion 302 can initiate a distress signal. Depression of the circular protrusion 304 can activate audio capturing and transmission capabilities. Finally, depression of the triangular protrusion 306 can activate video/image capturing and transmission capabilities.

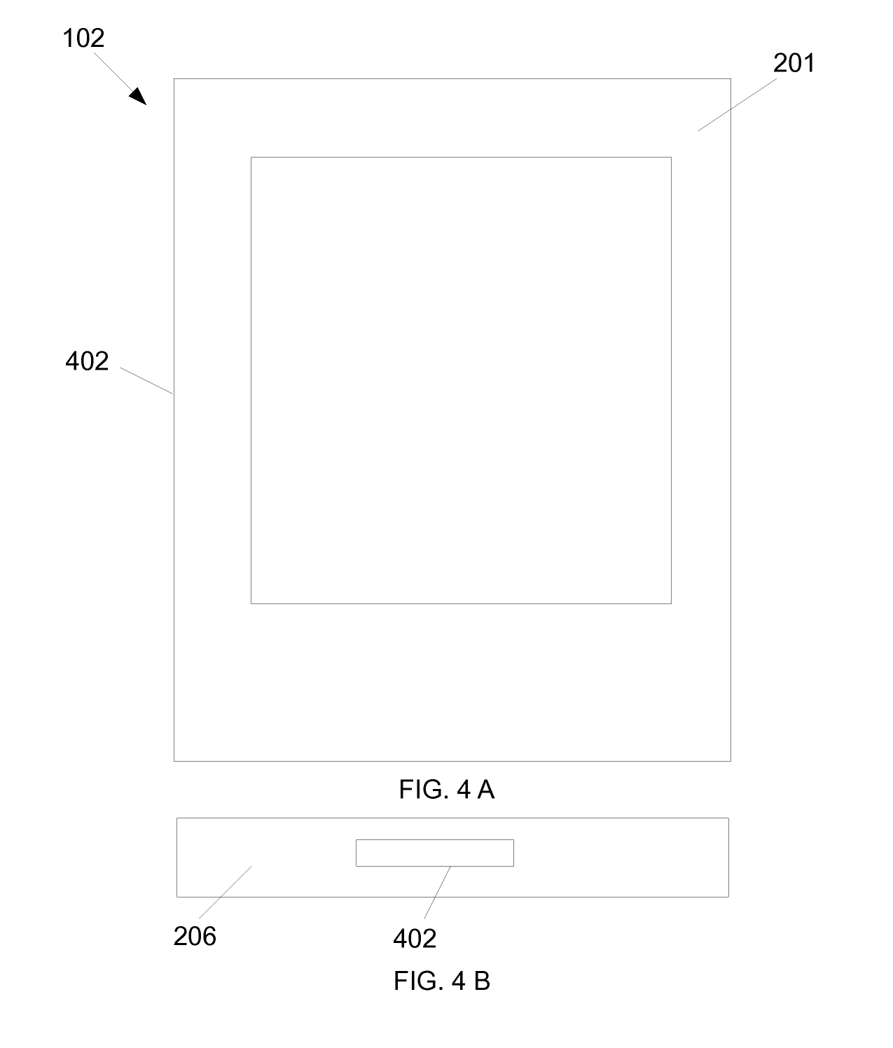

FIGS. 4A and 4B are front and side views, respectively, of a mobile device with flush portions in accordance with an embodiment of the present invention, respectively. The button 402 shown in FIG. 4B is on the same plane as the casing 104, so that it is not protruding or jutting out from the casing 104. Thus, the mobile device 102 has a clean, streamlined look. In this embodiment, the button 402 can be a haptic button, such that when the user 100 places their fingers over the button, the button 402 can vibrate or provide another touch-sensitive sensation to the user 100. The user 100 can easily locate the button 402 without looking at the mobile device 102 by simply feeling around for the haptic sensation.

In an embodiment, the button 402 can be located on any side, front, or back portion of the casing 201, and its placement is not limited to the embodiment show in FIG. 4B. Furthermore, multiple haptic buttons can be located on either side of the casing 201.

In yet another embodiment, multiple haptic buttons, each providing a different sensation can be utilized. For example, a first haptic button can provide a short vibration, while a second haptic button can provide a long vibration. The user 100 could then enter a sequence, such as, for example, two short haptic button presses and one long haptic button press, in order to trigger a distress signal.

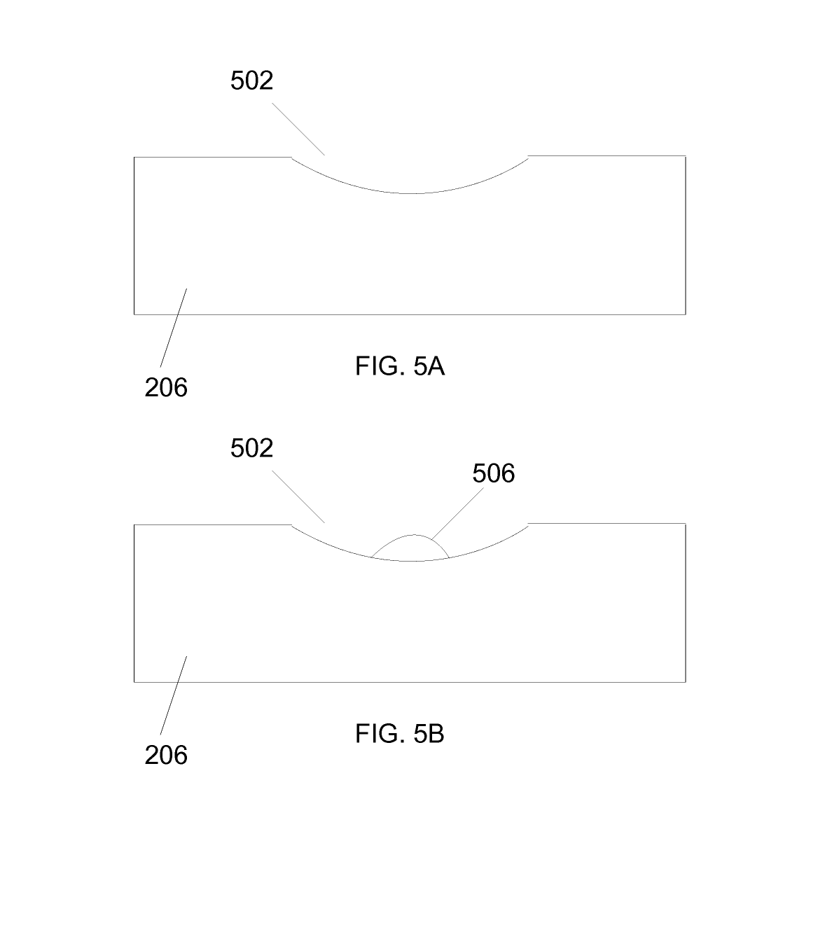

FIG. 5A is a side view of a mobile device with indented portions in accordance with an embodiment of the present invention. The mobile device 102 includes indentations 502 on the casing 201. The indentations 502 can include a touch sensitive layer 504 that can sense the user's finger pressure. Upon sensing the finger pressure, the distress alarm can be triggered. Similar to the other embodiments described above, the indentations 502 can be located on any side, front, or back portion of the casing 201, and its placement is not limited to the embodiment show in FIG. 5A. Furthermore, multiple indentations can be located on either side of the casing 201, and can be used in conjunction with each other so that the user can either simply apply pressure to one or more indentations simultaneously, or in a pre-determined sequence or order to trigger the distress alarm.

In yet another embodiment, the touch sensitive layer 504 can include fingerprint recognition technology. The mobile device 102 can include stored fingerprint data of multiple users. When the distress signal is sent, the fingerprint data of the user 100 is transmitted so that a third-party response provider can know the identity of the user 100.

FIG. 5B is a side view of a mobile device with an indented portion with a button in accordance with an embodiment of the present invention. In this embodiment, a button, such as a switch, click-button, slide-mechanism, tab, etc. is located within the indentation 502. Upon toggling the button, a distress signal is triggered.

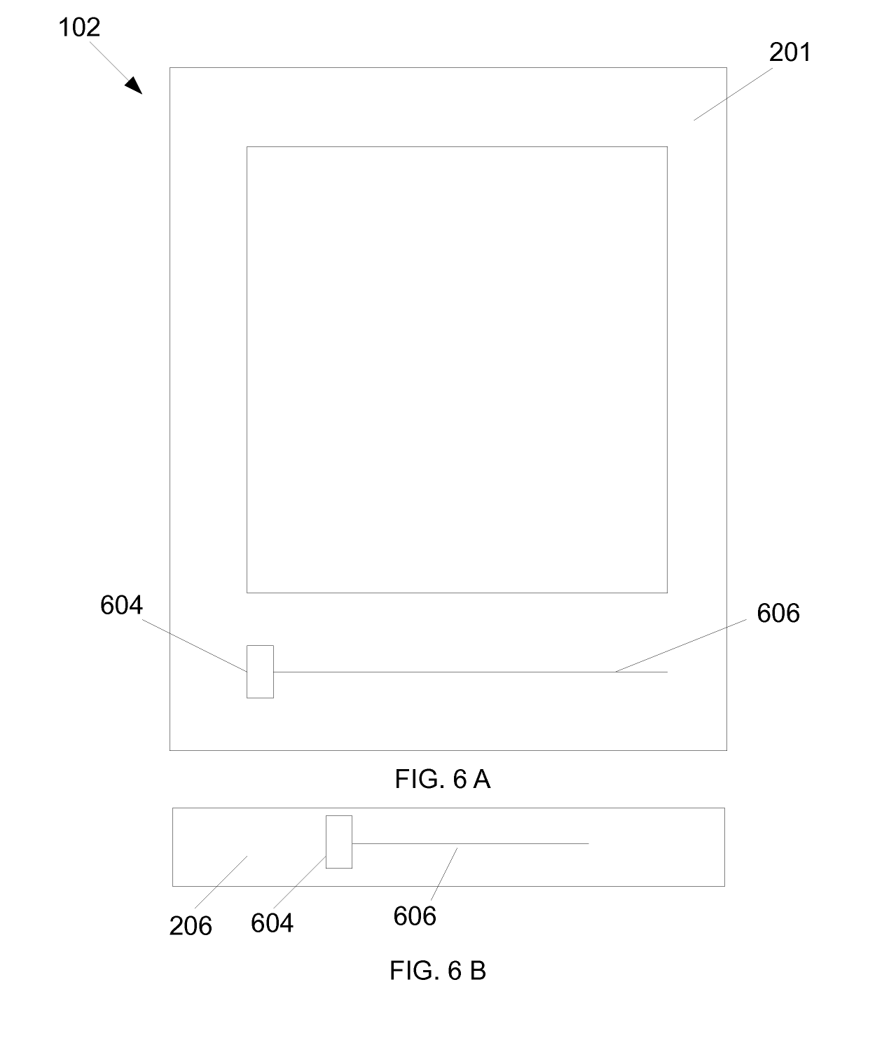

FIG. 6A is a front view of a mobile device with a mechanical slide switch in accordance with an embodiment of the present invention. The mobile device 102 includes a mechanical slide switch 604 on the casing 201. In an embodiment, the slide switch 604 is mounted on a runner 606. When the slide switch 604 is moved from one end of the runner 606 to the opposite end of the runner 606, and back again, within a pre-determined time period, a distress signal is triggered. For example, the distress signal would only be triggered if the user 100 moves the slide switch 604 back and forth two times within a three second period. The number of back-and-forth movements of the slide switch 604, and the time in which these number of movements needs to be completing in, can be pre-determined or pre-set by the user 100 or the mobile device manufacturer. The slide switch 604 and runner 606 can be located on any side, front, or back portion of the casing 201, and its placement is not limited to the embodiment show in FIG. 6A. FIG. 6B is side view of the mobile device 102 with the slide switch 604 located on the side 206 of the mobile device 102.

In yet another embodiment, instead of a slide switch, a rotary dial or turning dial can be used to trigger the distress signal.

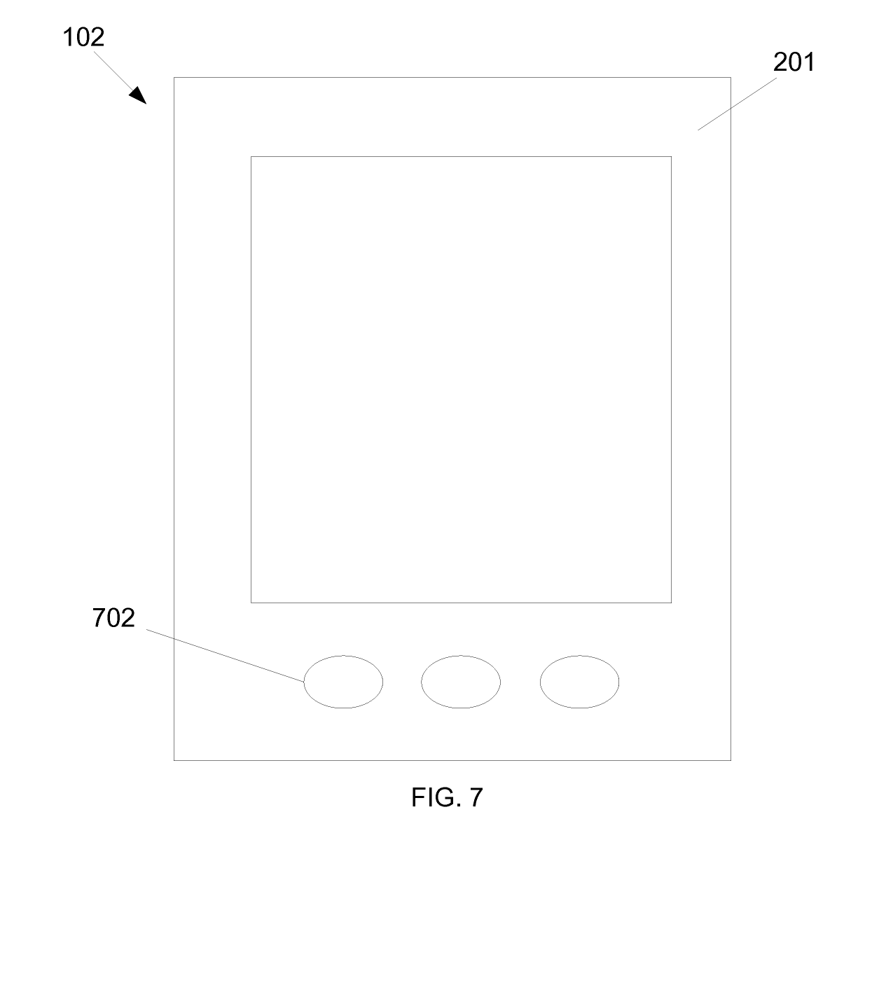

FIG. 7 is a front view of a mobile device with touch-sensitive buttons in accordance with an embodiment of the present invention. The mobile device 102 includes a plurality of touch-sensitive buttons 702 is located on the casing 201. In a preferred embodiment, the plurality of touch-sensitive buttons 702 are arranged in a straight row or column on the casing 201. In operation, the user 100 can slide their finger across the row or column of touch-sensitive buttons 702, effectuating a sliding motion. Such a movement would be difficult to emulate by accidental brushing while the mobile device 102 is in a pocket or purse.

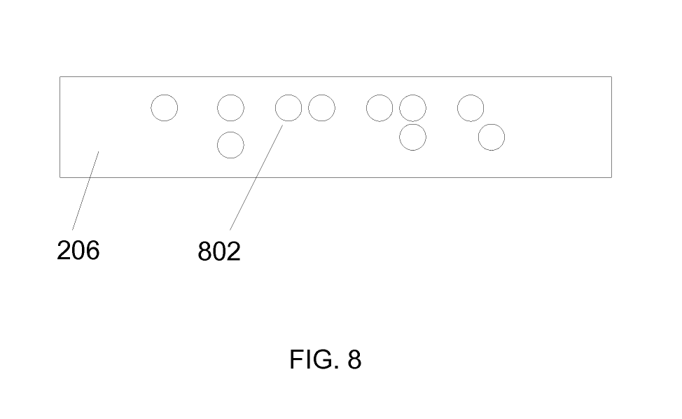

FIG. 8 is a side view of a mobile device with a Braille-type manipulation system in accordance with an embodiment of the present invention. The side 206 of the mobile device 102 (or any other portion of the casing 201) can include a Braille embossed section where the user 100 can trigger a distress signal, or send a message using the Braille alphabet. The message can be in the form of a text message or email that is transmitted from the mobile device 102 to a remote location.

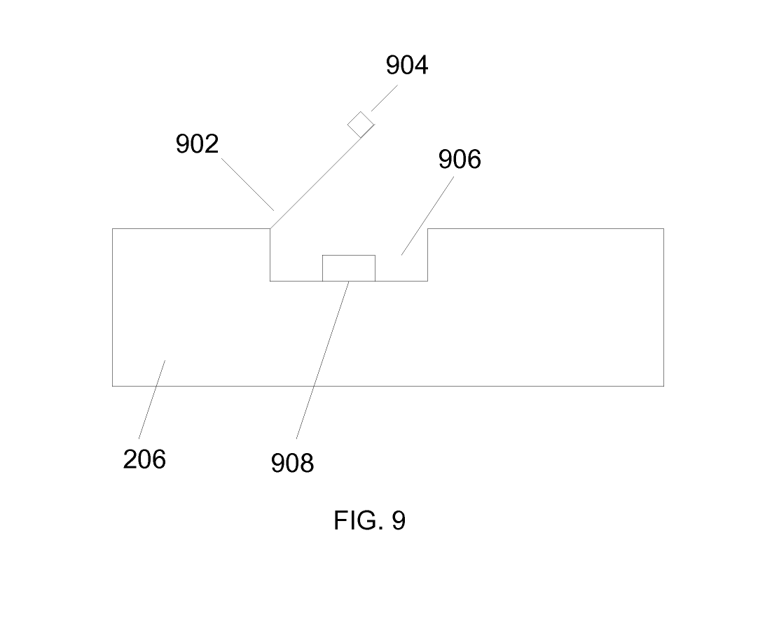

FIG. 9 is a side view of a mobile device with an access switch in accordance with an embodiment of the present invention. The casing 201 of the mobile device 102 includes an access port 906 having a liftable cover 902 supported by a hinge. In an embodiment, the cover 902 includes tactile portions so that a user can locate the cover 902 without looking at the mobile device 102. In yet another embodiment, the cover 902 is slidable, and can slide into the casing 201 to reveal the access port 906. Within the access port 906 is a recess having a button 908. The user 100 can depress the button 908 to trigger a distress signal.

In another embodiment, the access port 906 can include a touch sensitive layer, instead of a button, that can sense the user's finger pressure. Upon sensing the finger pressure, the distress alarm can be triggered.

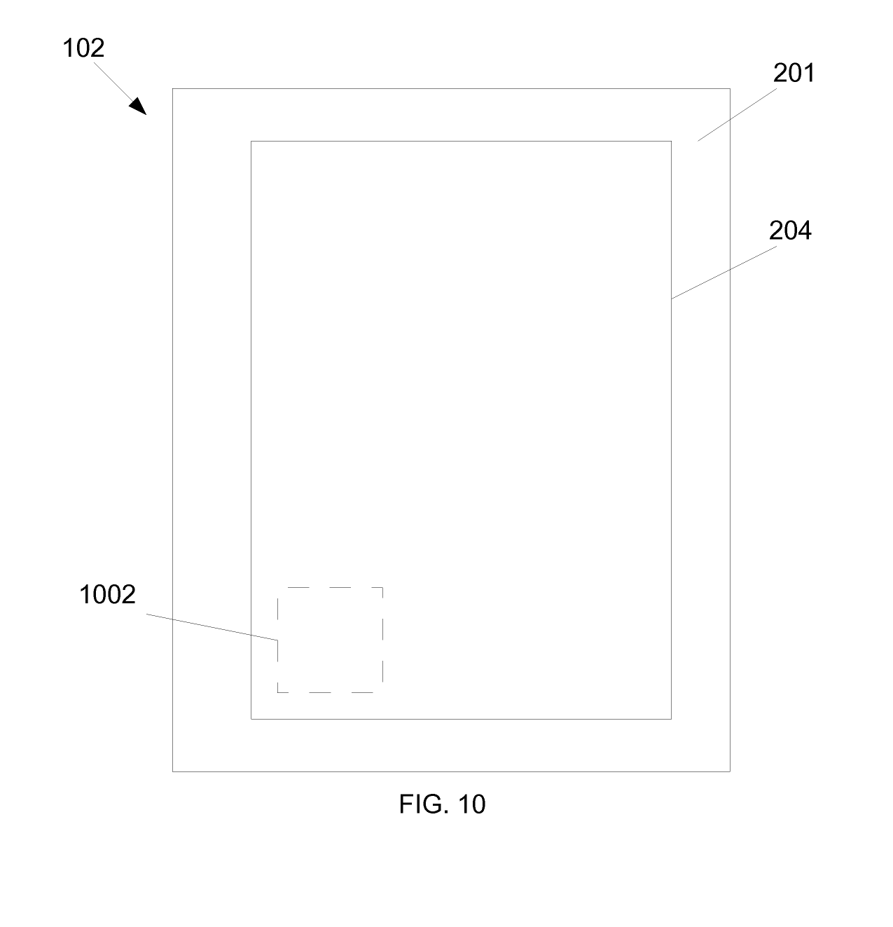

FIG. 10 is a front view of a mobile device with a dedicated alarm region on the screen in accordance with an embodiment of the present invention. The mobile device 102 includes a screen 204. Within the screen 204 is a dedicated region 1002 that the user 100 can touch in a pre-determined fashion to trigger a distress signal. In an embodiment, when the user's finger glides over the dedicated region 1002, a haptic sensation is triggered, indicating to the user 100 that they have located the dedicated region 1002. The user 100 can then enter an activation sequence of inputs, such as three long taps, or two short taps following by one long tap, etc. to trigger the distress signal.

The dedicated region 1002 can be software controlled, allowing for the user 100 or the mobile device manufacturer to set and modify the dedicated region 1002, as well as the activation sequence. In another embodiment, the dedicated region 1002 can be an embedded chip (i.e., hardware) placed within the screen 204. In this embodiment, the dedicated region 1002 is pre-set and cannot be changed. In yet another embodiment, the dedicated region 1002 is not on the screen 204, and can be on any portion of the casing 201 of the mobile device 102.

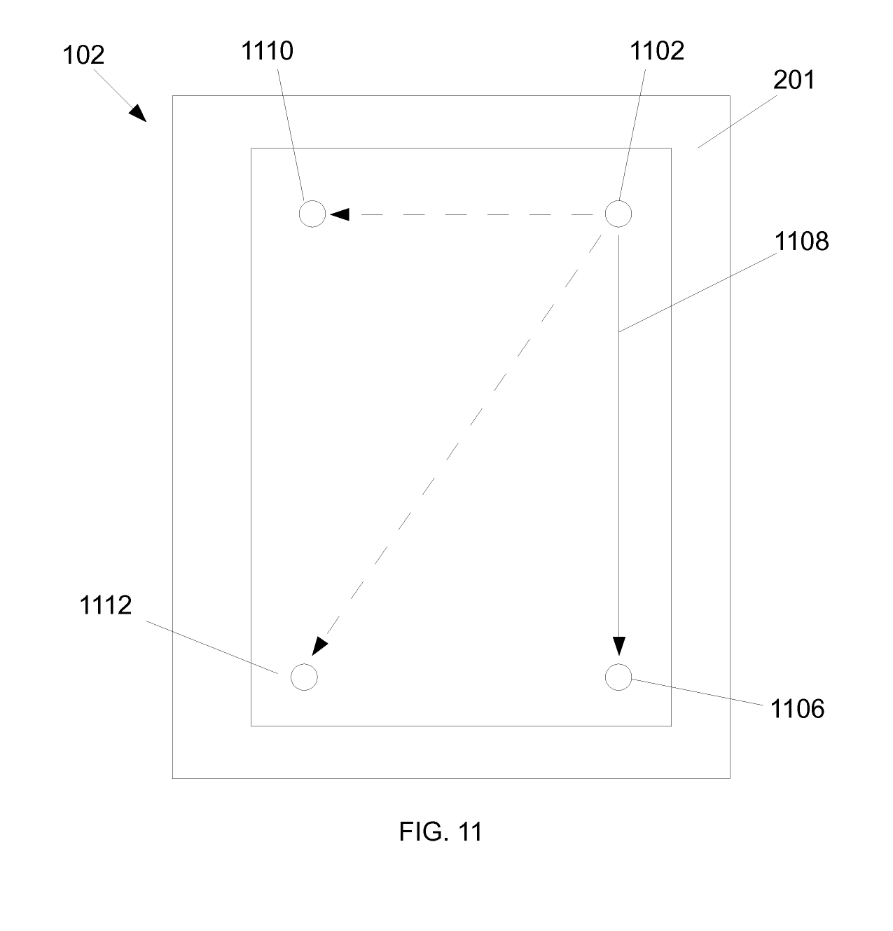

FIG. 11 is a front view of a mobile device with a dedicated slide region on the screen in accordance with an embodiment of the present invention. The mobile device 102 includes a screen 204 that is configured to sense a pre-determined sliding motion in order to trigger a distress signal. In an embodiment, when the user's finger glides over a starting point 1104, a haptic sensation is triggered, indicating to the user 100 that they have located the starting point 1104. In operation, the user 100 can slide their finger 1102 from the starting point 1104 to an ending point 1106 in the direction 1108 to trigger a distress signal. The starting point 1104 and the ending point 1106 can be software controlled, allowing for the user 100 or the mobile device manufacturer to set and modify the sliding region and start and end points. In yet another embodiment, more than two points can be used, such as three points connecting in a Z-shape pattern to trigger the distress signal.

In an embodiment, once the user 100 triggers the distress signal, an audible or visual indicator can be emitted from the mobile device 102. For example, an LED light on the mobile device 102 can be illuminated or can start to blink. In another example, a message can automatically be displayed on the screen 204 stating that a distress signal has been initiated. In another example, a pre-recorded message can automatically be played through a speaker on the mobile device 102.

In another embodiment, upon activation of the distress signal by the user 100, a pre-programmed event can be triggered in addition to the distress signal being transmitted to a third-party response provider. For example, the event can be turning on an automobile engine, activating an automobile or home security alarm system, turning on automobile or home lights, opening a garage door, locking or unlocking automobile or home doors and/or windows, activating a security camera or a web camera, etc.

Furthermore, the user 100 can enter a different sequence or touch a different combination of buttons or touch points on the mobile device 102 in order to activate different events. For example, referring to FIG. 11, as mentioned earlier, a vertical finger swipe from starting point 1104 to ending point 1106 can trigger a distress signal. In an embodiment, a horizontal swipe from starting point 1104 to ending point 1110 can trigger an event signal for turning on an automobile engine. Whereas a diagonal swipe from starting point 1112 to ending point 1110 can trigger an event signal to activate a home security alarm system.

In each of the embodiments described in FIGS. 2-11, the mobile device 102 can be in a locked or sleep state in the user's pocket, purse, handbag, etc. in order for the various distress signal triggering mechanisms to be activated. By having the device in a locked state, this would prevent the accidentally triggering of the distress signal.

In an embodiment, the mobile device 102 can include accelerometers and/or gyroscope mechanisms to determine its physical orientation. When the orientation is in flux based on accelerometer and gyroscope readings, this can be an indication that the device is in a pocket, purse, handbag, etc., and the mobile device 102 can automatically be placed in a locked mode, thereby enabling the distress signal triggering mechanisms.

In yet another embodiment, the mobile device 102 can include a camera. When the camera senses a transition from a lighted environment to a dark environment, indicating that the device has been placed in a pocket or handbag, the mobile device 102 can automatically be placed in a locked mode, thereby enabling the distress signal triggering mechanisms.

In another embodiment, if the mobile device 102 is in a purse, handbag, backpack, etc., the accelerometers and/or gyroscope mechanisms can determine if the user 100 is swinging their bag in a manner consistent with using the bag as a defensive tool. For example, if a woman is being chased or attacked, she may use her purse to beat or fend off the perpetrator. The swinging motion of the purse is likely to be extremely erratic. Upon sensing this erratic motion by the accelerometers and/or gyroscope mechanisms, the mobile device 102 inside the purse can trigger a distress signal.

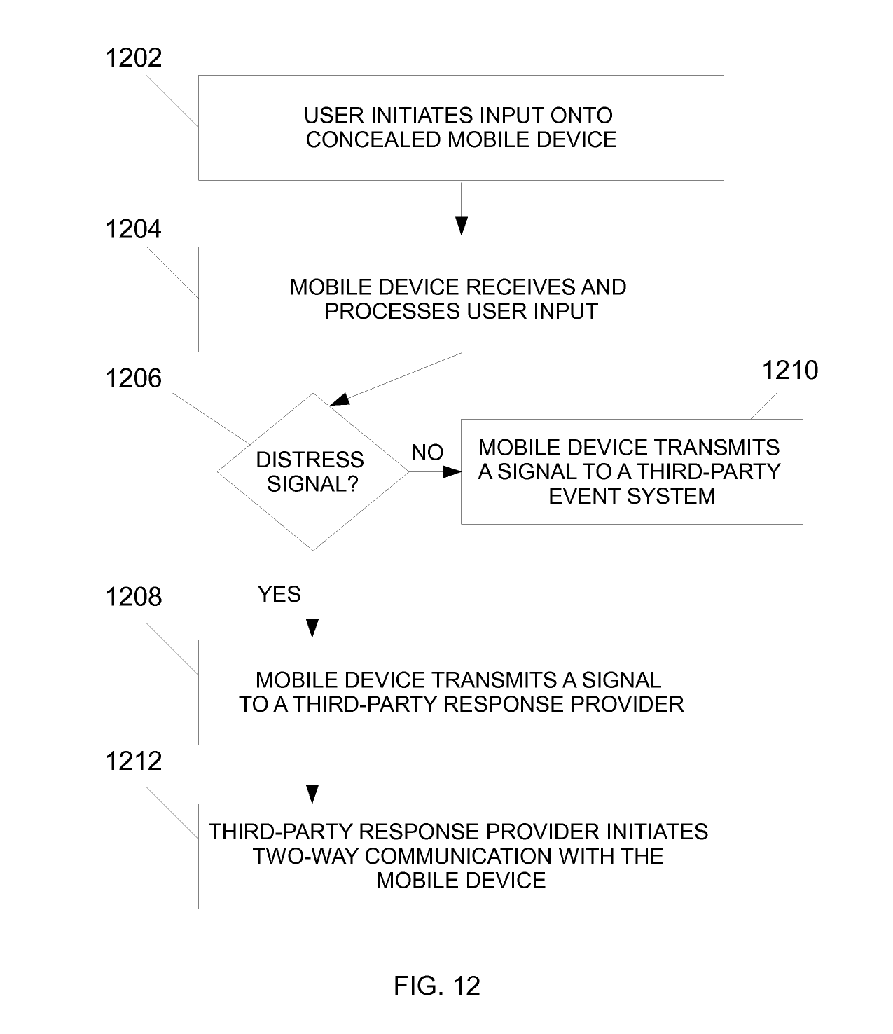

FIG. 12 is a flowchart of the method of triggering a distress signal in accordance with an embodiment of the present invention. In step 1202, the user 100 initiates an input according to one of the aforementioned methods that does not require the user 100 to look at the mobile device 102. Next, in step 1204, the mobile device 102 receives an input signal corresponding to the user input, and subsequently processes the input to determine a corresponding action. In step 1206, the mobile device 102 determines if the input signal corresponds to a distress signal, or to an event signal.

If the input signal corresponds to a distress signal, then in step 1208, the mobile device 102 transmits a distress signal to a remote location, such as to a third-party response provider. The distress signal can include position, audio, and video/image data, as well as any other identifying or information data that can assist the third-party response provider in assessing the user's environment/situation.

Alternatively, if the input signal corresponds to an event signal, then in step 1210, the mobile device 102 transmits an event signal to a third-party event system, such as a home security system, an automobile controller, etc.

In step 1212, the third-party response provider can initiate a two-way communication with the mobile device 102. For example, the third-party response provider can speak through a speaker or loudspeaker on the mobile device 102. In another embodiment, the third-party response provider can trigger an audible alarm or a pre-recorded message stating that the situation is being monitoring, and law enforcement officials are en route to the scene.

In another embodiment, instead of sending an automatic distress signal upon receipt of the aforementioned methods, the mobile device 102 can include a “Release 911” feature, which was described as “911-On-Call” in co-pending U.S. Non-Provisional patent application Ser. No. 12/862,117, filed on Aug. 24, 2010, entitled “Methods and Systems for Threat Assessment, Safety Management, and Monitoring of Individuals and Groups”, which is incorporated entirely by reference herein. Upon feeling uncertain or uneasy about a particular environment or situation, the user 100 can activate a stand-by signal by applying a constant, steady pressure to a certain portion of the mobile device 102. This stand-by signal is transmitted to a third-party response provider.

For example, the user 100 can depress a button, or touch a portion of the mobile device 102, in a pre-determined fashion as described above. As long as the user 100 keeps a constant, steady pressure on this particular portion of the mobile device 102, the stand-by signal is transmitted to a third-party response provider, namely a 911 emergency center or a private monitoring/security provider. Upon receipt of the stand-by signal, the response provider is put on alert that the user 100 is in a potentially threatening situation, but perhaps not necessarily in immediate danger. If the user 100 removes pressure from the portion of the mobile device 102, such as loosening their grip or letting go of the mobile device 102, the third-party response provider requests the user 100 to enter a code (either by input into the mobile device 102, or an audible code) to verify that the user 100 is not in danger. If such as input is not received within a pre-determined period of time, the third-party service provider escalates the situation in order to provide immediate assistance to the user 100.

In another embodiment, the distress signal can be triggered by voice commands. For example, the mobile device 102 can have an active microphone, such that the microphone is constantly picking up audible sounds, and the mobile device 102 is constantly processing these sounds in real-time. In the event of an attack, if the user 100 yells certain distress words, such as “Rape”, “Help”, “Attack”, “Burglar”, “Kidnapping”, “Robbery”, etc., the distress signal is automatically triggered. The microphone can be a highly sensitive microphone that can detect sounds even while the mobile device is in a concealed environment.

In another embodiment, the mobile device 102 can include voice recognition software so that only a registered user's voice can activate the distress signal. In another embodiment, a family may choose to register the voices of all family members (e.g. parents, children, elderly grandparents) into the mobile device 102 so that it can be activated by numerous family members.

In yet another embodiment, the distress signal can be triggered based on the user's physiological condition. The user 100 can have body sensors communicatively coupled to the mobile device 102 that are specifically tuned to recognize extreme stress consistent with attack, robbery, rape, hostage, and/or kidnapping situations. For example, the mobile device 102 can monitor the heart rate of the user 100. If the user's heart rate becomes abnormally elevated, is erratic, or if no pulse is detected, a distress signal is automatically triggered. In this embodiment, the mobile device 102 is communicatively coupled to the user's body sensors via short-range wireless communication protocols, such as RFID or Bluetooth.

In yet another embodiment, the user 100 can customize how their mobile device 102 connects and interacts with various emergency response options, such as 911 emergency centers, private monitoring/security providers 108, the user's personal friends/family network 110, police departments, emergency medical service (EMS) providers, fire and rescue departments, volunteer organizations, volunteers, employees, include federal agencies, task forces, non-governmental agencies, relief agencies and workers, and the military.

The various options, as well as the manner in which these emergency response options are combined allows a user to improve their safety across various dimensions, as described in more detail below.

In an embodiment, the user 100 can enable the mobile device 102 to identify and connect to the nearest emergency response provider. Upon activation of a distress signal, the mobile device 102 can receive location data of emergency response providers that are within a pre-determined vicinity of the user 100 from a security network. The user 100 can set the predetermined vicinity based on their environment. For example, if the user 100 is hiking in the woods and is in a fairly open and sparse area, the pre-determined vicinity could be set to 20 miles. On the other hand, if the user 100 is in a dense, highly populated area, such as a metropolitan area or a sporting event, the pre-determined vicinity could be set to 500 feet.

The mobile device 102 can receive information of emergency response providers that are within a pre-determined vicinity of the user 100, and either automatically inform these providers of the user's location and distress call, or display a list of these providers on the mobile device 102 so that the user 100 can select which provider(s) they would like to alert.

In another embodiment, the user 100 can enable the mobile device 102 to select a most appropriate emergency response provider, based on the user's environment, or other data input by the user 100 into the mobile device 102, or collected by sensors associated with the mobile device 102 or the security network. For example, if a user 100 is abducted an in a moving vehicle, the mobile device 102 can transmit speed and velocity data to the security network. Upon determination that the user 100 is in a moving vehicle, the security network can identify responders that in automobiles, helicopters, and other suitable vehicles capable of pursuing the user 100.

In yet another embodiment, as an additional filter, the user 100 can select which type of emergency response providers are notified after the above determinations are made. For example, the user 100 can select that fire fighters are never alerted, and only police officers are alerted. In another example, the user 100 can select that only volunteers such as Spartan, Samaritan, and neighborhood watch members are alerted, and that law enforcement is never contacted.

In yet another embodiment, the user 100 can configure the mobile device 102 so that the emergency response provider is selected automatically based on a time of day, location, or situation. For example, the user 100 can select that co-workers are alerted first during the hours of 9 am to 5 pm, when the user 100 is typically at work. From the hours of 5 pm to 6 pm, the user 100 can select that 911 as well as the security office at the user's workplace is contacted first, since this is the time when the user 100 is in the parking deck and then drives home. From 6 pm to 9 am, the user 100 can select that 911, neighborhood watch, and friends and family are contacted first, as the user 100 is typically at home during these hours.

In another example, if the user 100 is a student, and on campus during 9 am to noon, the user 100 can select that university police are contacted instead of local 911. This provides a faster and more efficient response since university police are on the site and are familiar with the campus grounds.

In another example, if the user 100 is attending a party, the user 100 can select that nearby volunteers are contacted as well as local 911. This again provides a faster and more efficient response for the user 100.

The user 100 can also set the emergency response provider based on a pre-defined situations, such as “Dinner with Friends”, “Blind Date”, “Shopping”, “Alone at Home”, etc. Pre-defined scenarios can be stored on a database coupled to the security network, where various scenario identifiers are associated with each scenario. For example, a scenario for “Driving to Work” can be stored in the database, along with acceleration and velocity identifiers, such as greater than 15 miles per hour, and time identifiers, such as 9 am to 10 am. If the user 100 initiates a distress signal, sensors on the mobile device 102 are read to determine the speed at which the mobile device 102 is travelling. These values are environment identifiers, and are sent to a processor, either within or remotely coupled to, the mobile device 102. The processor compares the environment identifiers against the scenario identifiers to determine if there is a match. If the user 100 is driving to work, then the speed of the mobile device 102 may be, for example, 30 miles per hour, and this environment identifier would match with the scenario identifier of “greater than 15 miles per hour”. This match, along with the timing data of the distress signal would indicate to the processor that the “Driving to Work” protocol should be followed.

In an embodiment, the scenario identifier and environment identifier can include a noise level, a sound, a temperature, a physiological value, a speed, an acceleration value, and a humidity value.

In yet another embodiment, the mobile device 102 and the security network use adaptive learning, so that over time, data collected by the mobile device 102 and the security network regarding the user's lifestyle, habits, movements, and friends and colleagues can be analyzed to automatically optimize the user's emergency response provider configuration.

The mobile device 102 provides a user interface that allows the user 100 to customize their emergency response provider and protocols. The user interface allows the user 100 to select the type of emergency response provider, the order in which different providers are contacted, as well as the situation, time, and location that trigger specific emergency response providers or protocols.

For example, the user 100 can select various local 911, “Release 911”, multiple responders, force multipliers, monitoring center, and safety network options from their mobile device 102. In another embodiment, the user 100 can customize their emergency response provider and protocols from any computing device coupled to the security network, and not just their specific mobile device 102.

The user can also choose how their mobile device 102 will function for safety. For example, the user 100 can configure their mobile device 102 stating, “if I drop the phone in the next 5 minutes, call 911 and let my family know where I am”. The mobile device 102 has voice recognition technology to capture spoke commands and convert them to instruction signals to program the mobile device's security protocols.

The system allows a user 100 to customize their mobile device 102 and available security responders and protocols based on their specific situation and needs.

In yet another example, the user 100 can instruct the mobile device 102 to call 911 if a specific button is pressed and held for five seconds, but only alerting the safety network if the button is pressed once followed by the command “Hey Joe, how are you?” The user 100 could configure the mobile device 102 so that pressing the volume up button connects to 911 but hitting the volume down button causes an automatic recording of “Police are enroute” to be emitted from a speaker of the mobile device 102.

In another example, the user 100 may want to have 911 contacted anonymously and only when the press the volume up button three times. The mobile device 102 will then connect to 911 but also “ring” the user 100, so the user 100 can answer as if things are normal but 911 will be on the call.

While the principles of the disclosure have been illustrated in relation to the exemplary embodiments shown herein, the principles of the disclosure are not limited thereto and include any modification, variation or permutation thereof.

1. A system for customizing an emergency response protocol, comprising:
an interactive menu configured for display on a mobile device, the interactive menu displaying a list of security providers and a list or security provider options;
input means on the mobile device allowing selection of at least one security provider and at least one security provider option; and
a processor coupled to the mobile device and configured to transmit a signal to the selected security provider based on the selected security provider option.

2. The system of claim 1, wherein the security providers are selected from a group consisting of a 911 center, a private security monitoring center, a police department, security volunteers, and a fire department.

3. The system of claim 1, wherein the security provider options includes a time of day in which the selected security provider is contacted.

4. The system of claim 1, wherein the security provider options includes a scenario in which the selected security provider is contacted.

5. The system of claim 1, wherein the security provider options includes a selecting an order in which multiple security providers are contacted.

6. The system of claim 1, wherein the security provider options includes blocking contact to the selected security provider.

7. A method of customizing security responses, comprising:
receiving, via an interface on a mobile device, a selection of a security provider;
receiving, via the interface, a time range associated with the security provider;
storing, on a processor coupled to the mobile device, the selected security provider and the time range;
receiving, via the mobile device, a distress signal having a timestamp; and
transmitting, from the processor, the distress signal to the security provider if the timestamp is within the time range.

8. The method of claim 7, wherein the interface displays at least two security providers for selection.

9. The method of claim 7, wherein the time range is a range of hours.

10. The method of claim 7, wherein the time range is a range of days.

11. The method of claim 7, wherein the processor is located within the mobile device.

12. The method of claim 7, wherein the processor is located remotely from the mobile device.

13. The method of claim 7, wherein the mobile device includes a touch-sensitive display.

14. A method of customizing security responses, comprising:
receiving, via an interface on a mobile device, a selection of a security provider;
receiving, via the interface, a scenario associated with the security provider, wherein the scenario includes a scenario identifier stored on a processor coupled to the mobile device;
receiving, via the mobile device, a distress signal having an environment identifier;
determining, via the processor, if the environment identifier is associated with the scenario; and
transmitting, from the processor, the distress signal to the security provider if the scenario identifier equals the environment identifier.

15. The method of claim 14, wherein the processor determines the scenario identifier is selected from a group consisting of a noise level, a sound, a temperature, a physiological value, a speed, an acceleration value, and a humidity value.

16. The method of claim 14, further comprising displaying, on the interface, a list of predefined scenarios.

17. The method of claim 16, wherein the pre-defined scenarios are stored on the processor.

18. The method of claim 14, wherein the processor is located within the mobile device.

19. The method of claim 14, wherein the processor is located remote from the mobile device.

20. The method of claim 14, wherein the environment identifier is selected from a group consisting of a noise level, a sound, a temperature, a physiological value, a speed, an acceleration value, and a humidity value.
